(19) United States
(12) Patent Application Publication
(10) Pub. No.: US 2026/0205594 A1
(43) Pub. Date: Jul. 16, 2026

(54) METHOD OF CREATING A THREE DIMENSIONAL IMAGE OF A TARGET SITE

(71) Applicant: Government of the United States as represented by the Secretary of the Air Force, Wright-Patterson AFB, OH (US)

(72) Inventors: Wei Cui, Falls Church, VA (US); Animesh Shastry, College Park, MD (US)

(21) Appl. No.: 19/020,621

(22) Filed: Jan. 14, 2025

(51) Int. Cl. H04N 19/132; G06T 15/00; H04N 19/119; H04N 19/136; H04N 19/46

(52) U.S. Cl. CPC H04N 19/132; G06T 15/00; H04N 19/119; H04N 19/136; H04N 19/46

(57) ABSTRACT

A method of creating a 3D image of a target site, preferably an target site. The method comprises the steps of gathering an RGB plurality of raw RGB images and a depth plurality of raw depth images representing the target site, serializing the RGB plurality and the depth plurality for offboard transmission. The RGB images and depth images are transmitted at sub-GHz frequencies for offboard decompression and photogrammetric constructing of a 3D map of the target site. This method decouples the tradeoff between low frequency bandwidth transfer limitations and high frequency obstruction penetration limitations.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to creating three dimensional images of a target site, particularly to creating indoor three dimensional images and more particularly to creating three dimensional images in real time from drone transmission.

### BACKGROUND OF THE INVENTION

Three dimensional images (3D images) have been used for locating points of interest, finding hostile actors, mapping, determining building size, etc. Such 3D images may originate from drone mounted cameras. As used herein, drones are unmanned aerial vehicles which fly through a target site under control of a remote operator or may be ambulatory for movement on a support surface. The camera transmits its two dimensional (2D) photos to a computer for processing into 3D images. The computer is remote from the drone for safety of the operator. As used herein, a target site is a space which may be outdoors or more likely indoors where the transmission benefits of the present invention can be used. The target site may comprise one room or several rooms. The target site may be a hostile environment, requiring the drone operator to be remote therefrom for safety and proximity to the remote computer.

Such transmission may be bandwidth limited due to the large number of images from the photographs necessary to accurately map the space under consideration and frequencies most effective for indoor spaces. There is an inherent tradeoff in the frequencies for such mapping. Lower frequencies provide enhanced penetration of walls and delivers enhanced coverage. But these low frequencies have intrinsically lower transfer rates than higher frequencies. Furthermore, 3D mapping consumes a large amount of memory, and many existing 3D mapping apps running on smartphones crash due to memory overrun.

Accordingly, it is an undertaking of this invention to decouple the tradeoff between low frequency bandwidth transfer limitations and high frequency obstruction penetration limitations. It is particularly an object of this invention to penetration limitations. It is particularly an object of this invention to provide a transfer method suitable for real time creation of 3D images from a moving drone mounted camera.

### SUMMARY OF THE INVENTION

In one embodiment the invention comprises a method of creating a 3D image of a target site, the method comprising the steps of: gathering an RGB plurality of raw RGB images and a depth plurality of raw depth images of the target site; serializing the RGB plurality of raw RGB images and the depth plurality of raw depth images for offboard transmission; offboardingly decompressing RGB plurality of raw RGB images and a depth plurality of raw depth images and photogrammetrically constructing a 3D map of the indoor space from the decompressed RGB images, the decompressed depth images, and the odometry. This method may further comprise the steps of serializing the RGB plurality of RGB raw images and the depth plurality of raw depth images by: downsampling the raw RGB images and the raw depth images; compressing the raw RGB images to 30 kB+/−5 kB; generating a robot odometry comprising 7 double-precision floating-point numbers, a robot odometry quality comprising 1 integer, an odometry timestamp comprising 1 double-precision floating-point number, a RGB image timestamp comprising 1 double-precision floating-point number; applying the RGB robot odometry to a RGB header of the compressed RGB image; generating a depth image timestamp; applying the depth image timestamp to a header of the compressed depth image; splitting the compressed RGB image into plural RGB data chunks, each RGB data chunk consisting of a RGB timestamp, a visual inertial odometry, a visual inertial odometry timestamp and a signal quality, each RGB data chunk having a byte size of 30 kb+/−5 kB and splitting the compressed depth image into plural depth data chunks, each depth data chunk consisting of a depth timestamp, each depth data chunk having a byte size of 30 kb+/−5 kB.

In another embodiment the invention comprises a method of creating a 3D image of a target site, the method comprising the steps of: gathering an RGB plurality of raw RGB images and a depth plurality of raw depth images of the target site; downsampling the raw RGB images and the raw depth images to 0.5 Hz to 5 Hz; compressing the raw RGB images to reduce image size and to save bandwidth for transmission; applying a robot odometry comprising 7 double-precision floating-point numbers, a robot odometry quality comprising 1 integer, an odometry timestamp comprising 1 double-precision floating-point number, a RGB image timestamp comprising 1 double-precision floating-point number to a RGB header of the compressed RGB image; applying a depth image timestamp comprising 1 double-precision number to a header of the compressed depth image; splitting the compressed RGB images into plural RGB data chunks, each RGB data chunk consisting of a RGB timestamp, a visual inertial odometry, a visual inertial odometry timestamp, and a odometry quality, and a compressed RGB image, each RGB data chunk having a byte size of 30 kb+/−5 kb; splitting the compressed depth images into plural depth data chunks, each depth data chunk consisting of a depth timestamp and a compressed depth image, each depth data chunk having a byte size of 30 kb+/−5 kb; alternatingly transmitting plural RGB data chunks and plural depth data chunks from a data collection location to an offboard processor at a frequency of 0.5 Hz to 5 Hz; assembling the RGB and depth data chunks into compressed RGB and depth images, odometry quality, and odometry at the offboard processor; j) decompressing the RGB images and depth images and photogrammetrically constructing a 3D map of the target site from the decompressed RGB images, decompressed depth images, and odometry.

### BRIEF DESCRIPTION OF THE DRAWINGS

FIG. 1 is a schematic view of a drone, offboard processor and target site.

FIG. 2 is a schematic representation of 3D image processing according to the prior art.

FIG. 3 is a schematic representation of a system according to the present invention.

FIG. 4 is a schematic representation of two computers linked according to the present invention.

FIG. 5 is an architecture of the serialization of RGB images.

FIG. 6 is an architecture of the serialization of depth images.

FIG. 7 is a flowchart of a method according to the present invention.

FIG. 8 is a flowchart of a method according to the present invention.

FIG. 9 is a flowchart of a method according to the present invention.

### DETAILED DESCRIPTION OF THE INVENTION

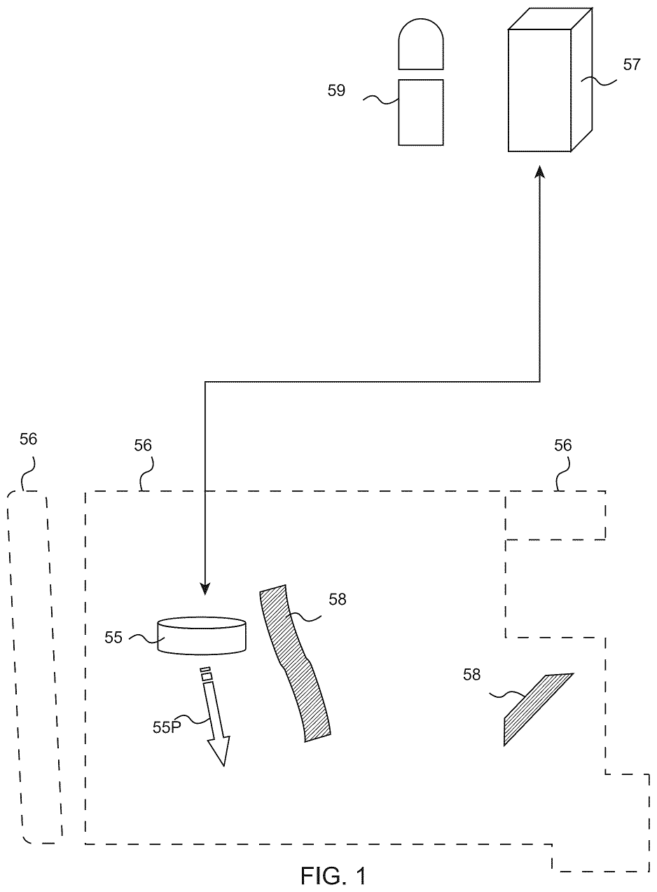

Referring to FIG. 1, a drone 55 may be used to conduct 3D mapping of a target site 56. The drone 55 may be ambulatory or flight enabled. Data from the drone 55 are serialized for wireless or wired transmission to an offboard processor 57, such as a laptop, cellphone, mainframe, etc. The target site 56 is a defined area of interest which may be indoors, outdoors or a combination thereof and comprise contiguous or discrete areas with or without obstructions 58 therein. The offboard processor 57 may transmit pre-programmed instructions or real time warnings back to the drone 55. Personnel 59 in communication with the processor 57 may then adjust or repeat the path of the drone 55 to avoid or repeat the path 55P as needed. If desired, plural drones 55 may be used with each drone 55 transmitting data from a different portion of the target site 56 to more rapidly complete the mission.

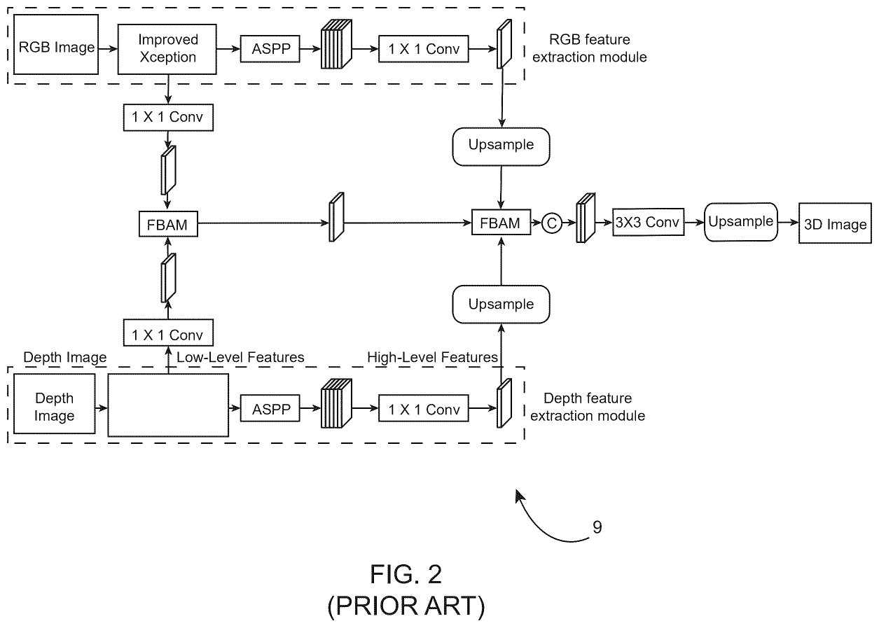

Referring to FIG. 2, the 3D image process 9 according to the prior art uses separate image trains for the RGB image and the depth image. The RGB image and the depth image are upsampled and combined in parallel to make the 3D image.

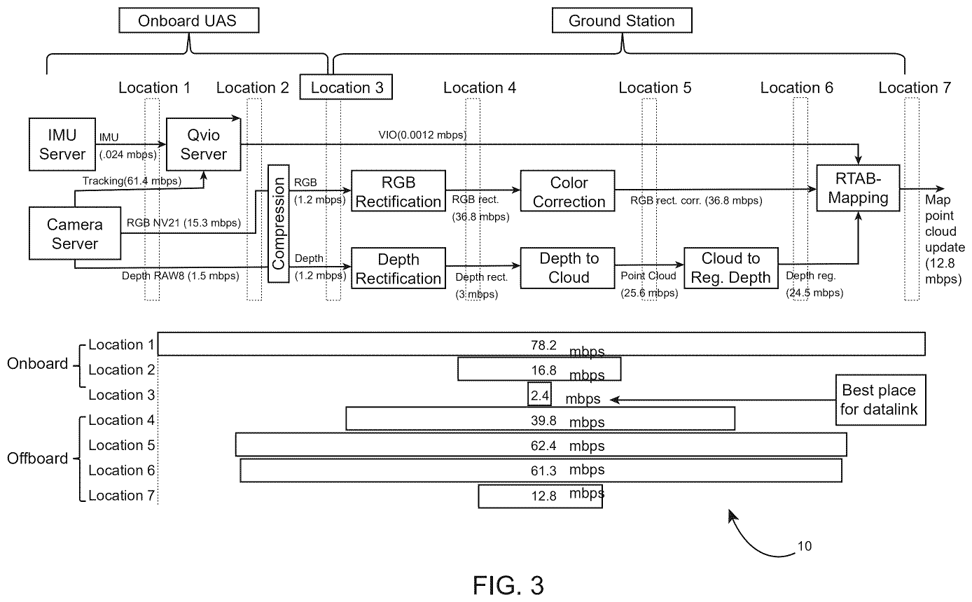

Referring to FIG. 3, in contrast to the prior art the present invention, in one embodiment, comprises a method 10 of creating a 3D image of a target site 56. The method comprises the steps of gathering an RGB plurality of raw RGB images and a depth plurality of raw depth images of the target site. This step uses an RGB image, 4k high-resolution, low-light sensor for an integrated AI companion computer, such as VOXL2.

The image capture process involves the following steps. First, light from the scene enters the lens and hits the image sensor. The photodiodes in each pixel convert the incident light into electrical charges. Electrical charges are accumulated in the photodiodes over a period of time, known as the exposure time. The accumulated charges are read out from each pixel and converted into a digital signal using analog to digital conversion (ADC). The digital signal is then converted into a digital code. The digital code represents the intensity of the light at each pixel. The digital codes from all pixels are processed and combined to form a complete image.

The image sensor may have from 640×480 to 3840×2160 pixels, for adequate light collection, even under low-light conditions. The photodiodes have 60% to 90% quantum efficiency, to convert a suitable percentage of incident light into electrical charges. The image sensor may use correlated double sampling and noise reduction algorithms, to reduce noise and thereby improve image quality.

The image sensor may capture 1 to 30 frames per second, to support real-time computer vision application. The image sensor may have 1 ms to 10 ms latency, for responsive image capture for object tracking and obstacle 58 avoidance.

A VOXL2 time of flight (TOF) depth sensor, which is a 3D depth sensor that uses the TOF principle to measure distances and create high-resolution 3D point clouds, has been found suitable. The TOF principle is based on measuring the time it takes for a light signal to travel from the sensor to an object and back. The VOXL 2 TOF depth sensor uses a light source, typically a laser or an LED, to emit a modulated light signal towards the scene. The light signal bounces off objects in the scene and returns to the sensor, where it is detected by a photodiode or a photodetector.

The image capture process has the following steps. The light source emits a modulated light signal towards the scene. The modulation frequency is typically in the range of 10-100 MHz. The light signal bounces off objects in the scene and returns to the sensor. The returning light signal is detected by a photodiode or a photodetector. The phase of the returning light signal is measured and compared to the phase of the emitted light signal. The phase difference is directly proportional to the distance between the sensor and the object. The distance to the object is calculated using the phase difference and the speed of light.

The various distances to the objects are used to generate a 3D point cloud, which is a collection of 3D coordinates that represent the scene. The depth values are then mapped to a grayscale color palette, where each depth value corresponds to a specific grayscale intensity. The grayscale intensity is represented as a value between 0 and 255, where 0 represents 0 meters and 255 represents 5 meters.

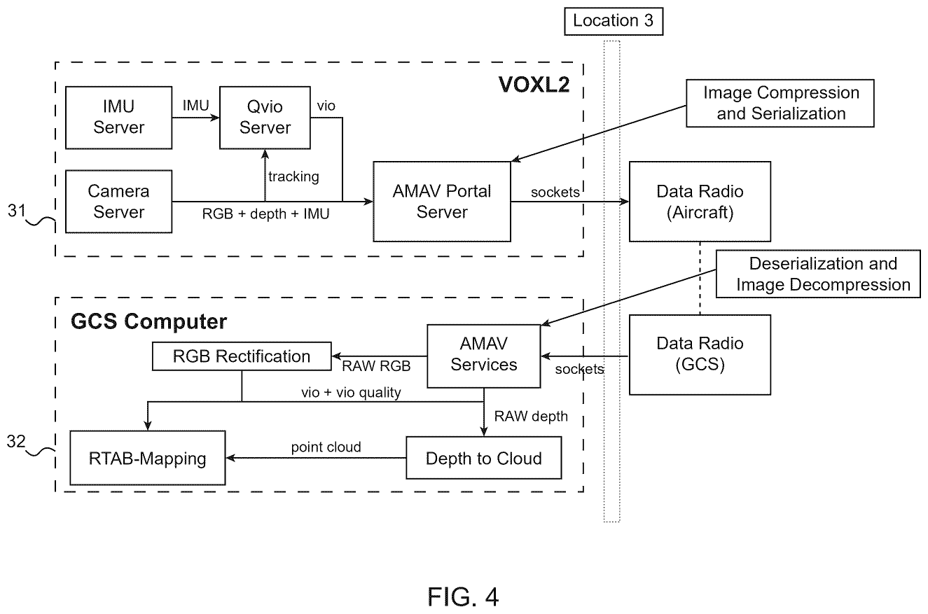

Referring to FIG. 4, the RGB plurality of raw RGB images, and a depth plurality of raw depth images are serialized as raw odometry data for offboard transmission. The raw odometry data are transferred from the sensors through Modal Pipe Architecture (MPA) to AMAV-Portal (AMAV modified VOXL-Portal) 31, where one RGB image, one odometry, one odometry signal, the RGB image, and the odometry timestamp, are serialized in the following data chunks. The ground control system computer 32 also may use AMAV.

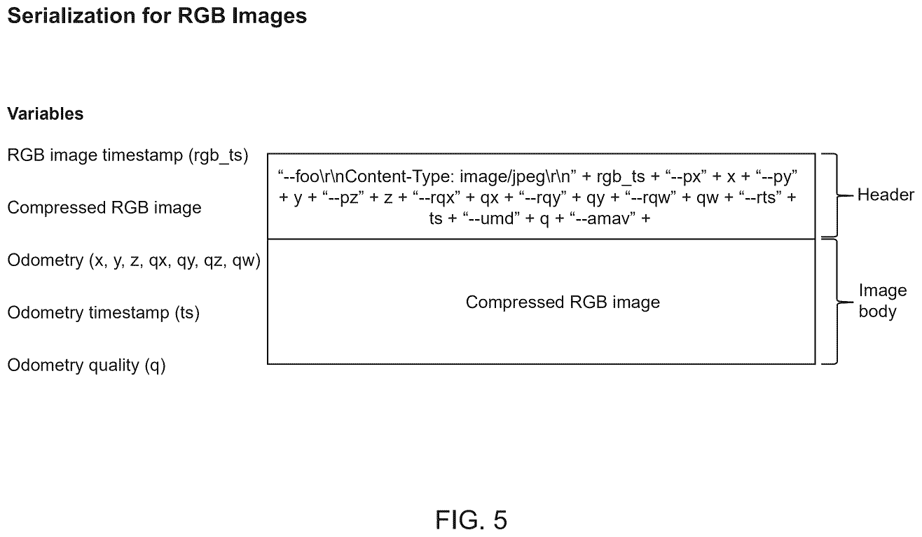

Referring to FIG. 5, the RGB image is compressed using JPEG compression. The RGB compressed image includes a header and an image body. The header has the following variables: an RGB image timestamp (rgb_ts); odometry; (x, y, z, qx, qy, qz, qw); an odometry timestamp (ts) and odometry quality (q).

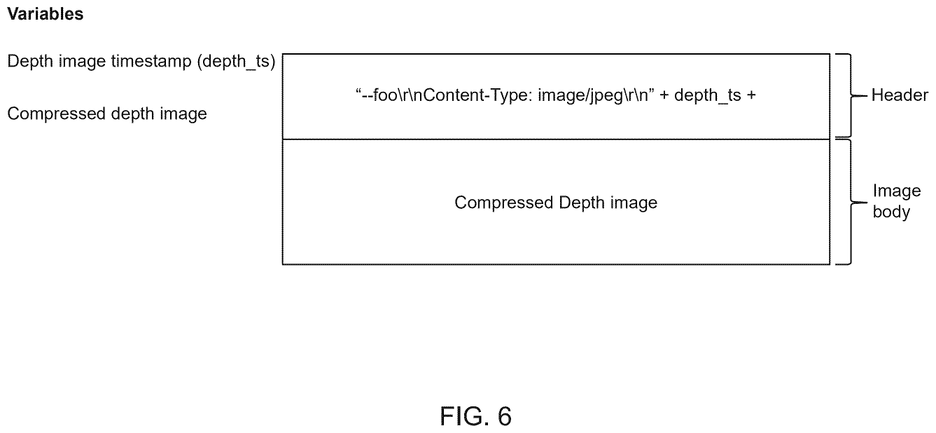

Referring to FIG. 6, the depth image is compressed using JPEG compression. The depth compressed image includes a header and an image body. The header has the following variable: depth image timestamp (depth_ts). Compression of the images may use any suitable encoding process, such as Huffman encoding, a run-length encoding process and a zig-zag reordering process.

Referring back to FIG. 4, the next step is to offboardingly decompress a RGB plurality of raw RGB images and a depth plurality of raw depth images at an offboard processor 57. The offboard processor 57 may be a remote laptop, cellphone at a ground station or mounted on another unmanned drone 55.

The first step in decompression is bitstream extraction. The bitstream is then decoded using a suitable process, such as Huffman decoding, i.e. the inverse of the Huffman encoding process used during compression. The Huffman-decoded bitstream is decoded using run-length decoding, which is the inverse of the run-length encoding process used during compression. The run-length decoded bitstream is reordered in a zigzag pattern, which is the inverse of the zigzag reordering process used during compression. The zigzag-reordered bitstream is quantized, which involves multiplying the coefficients by a quantization factor which may have been used during compression. The quantized coefficients are transformed using the inverse discrete cosine transform, which is the inverse of a discrete cosine transform transformation used during compression.

Chrominance components of Cb and Cr are then upsampled to the original resolution of a YCbCr image. The image is then converted from the YCbCr color space to the RGB color space. The final image is reconstructed from the decompressed data.

A RGB-D, stereo and/or LIDAR graph-based simultaneous location and mapping (SLAM) approach based on an incremental appearance-based loop closure detector may be utilized. A loop closure detector, particularly using a bag-of-words approach, may be used to determine how likely a new image comes from a previous location or a new location. When a loop closure hypothesis is accepted, a new constraint may be added to the map graph. Optionally a graph optimizer may be used to minimize errors in the map. A memory management approach is used to limit the number of locations used for loop closure detection and graph optimization, so that real-time constraints on large-scale environments are always respected. The program Real-Time Appearance-Based Mapping (RTAB-Map) program may be used to construct 3D maps in real-time.

RTAB-Map is a graph-based SLAM useful to construct 3D maps in real-time. Particularly, RTAB-Map is a SLAM library which can build 3D maps using both visual data and depth data. RTAB-Map, and similar programs have several elements which cooperate to build 3D maps in real-time. For example, RTAB-Map provides a sensor interface that allows connection to various sensors, such as cameras, lidars, and stereo vision systems. RTAB-Map extracts features from the visual and depth data, such as corners, edges, and lines. RTAB-Map matches the extracted features between consecutive frames to estimate the camera motion and build a graph-based map. RTAB-Map optimizes the graph-based map using various techniques, such as pose graph optimization and bundle adjustment. RTAB-Map also updates the 3D map in real-time using the optimized graph-based map.

RTAB-Map builds 3D maps in real-time with the following steps. RTAB-Map acquires visual and depth data from the sensors, such as cameras, lidars, or stereo vision systems. RTAB-Map extracts features from the visual and depth data and matches them between consecutive frames to estimate the camera motion. RTAB-Map builds a graph-based map using the matched features and camera motion estimates. RTAB-Map optimizes the graph-based map using various techniques, such as pose graph optimization and bundle adjustment. RTAB-Map updates the 3D map in real-time using the optimized graph-based map. RTAB-Map detects loop closures and updates the map accordingly.

The system may use an autonomous AI copilot, such as the ModalAI VOXL2 platform available from Modal AI Robotic Perception of San Diego, CA. An AMAV modified VOXL-Portal receives the RGB images from the sensor at 30 Hz+/−5 Hz. The portal may drop five frames every six frames to downsample the RGB images to 5 Hz. Similarly, AMAV-Portal downsamples the raw depth images and the odometry to 5 Hz. A JPEG quality setting of 20 has been experimentally obtained so that the RGB images can be compressed from 900 kB to 30 kB and found to work well.

A timestamp for the RGB image is generated and is provided by a sensor, preferably by a 4k high-resolution low-light sensor. The timestamp for the odometry is generated by the VOXL2 system clock. The odometry quality is the inverse of the odometry variance, which describes the uncertainty of the estimated pose and orientation.

The timestamp for the RGB image is generated and provided by the Image Sensor 4k High-resolution Low-light Sensor. The timestamp for the odometry is generated by VOXL2 system clock. The odometry quality is the inverse of the odometry variance, which describes the uncertainty of the estimated pose and orientation.

The variance is derived from state estimation, sensor noise modeling, and statistical uncertainty propagation. For filter-based (such as Extended Kalman Filter) VIO systems:

Given a state transition model:

$${x}_{k + 1} = F {x}_{k} + w \qquad Eq . 1$$

wherein
xₖ is the state vector at step k, F is the state transition Jacobian and w is the process noise with covariance Q.

$$The propagated covariance matrix is {P}_{k}^{-} = F {P}_{k} {F}^{T} + Q . \qquad Eq . 2$$

For the covariance update when a measurement z is received:

$$K = {P}_{k + 1}^{-} {{H}^{T} ( H {P}_{k + 1}^{-} {H}^{T} + R )}^{- 1} , \qquad Eq . 3$$

$$wherein {P}_{k + 1} = ( I - KH ) {P}_{k + 1}^{-} \qquad Eq . 4$$

and H is the measurement model Jacobian, R is the measurement noise covariance and K is the Kalman gain. The diagonal elements of P give the variance terms for each state, i.e. position and orientation.

The programming language C++ may be used to concatenate the odometry data, odometry quality, two timestamps, and compressed RGB image into a single buffer, particularly by using the sprintf( ) function. The timestamp for the depth image is generated and provided by the VOXL2 Time of Flight (TOF) depth sensor. The sprintf( ) function in C++ may then be used to concatenate the timestamp and compressed depth image into a single buffer, effectively combining the two data streams into a unified data chunk.

These steps are repeated as necessary to serialize the RGB images, odometry and other data as necessary into multiple data chunks. The same steps are repeated to serialize the depth images and timestamps into multiple data chunks.

One may use an if-statement in C++ to check the signal quality value in AMAV-Service software. AMAV-Portal checks for confirmation of successful transmission of a data chunk. It reduces the transmission frequency to 0.5 Hz when confirmation is not received within 0.1 seconds and increases the transmission frequency to 5 Hz when confirmation is received within 0.1 seconds.

The drone 55 may use a software mutex to transmit the RGB data chunks and the depth data chunks sequentially (rgb, depth, rgb, depth, . . . ) via a TCP/IP socket. The sensor data streams are preferably offboard processed on the ground station where the data chunks are deserialized to construct the ROS messages. Particularly, the software mutex ensures that only the data chunks are transmitted sequentially ( . . . rgb, depth, rgb, depth . . . ). The function send( ) in C++ may be used to send the data chunks through a TCP/IP socket.

Software may then be used to timestamp compressed RGB images, timestamp compressed depth images, timestamp odometry and timestamp odometry quality, all collected by AMAV-Portal concurrently using multiple threads. AMAV-Services then applies JPEG decompression to reconstruct raw RGB and depth images in ROS to yield timestamped raw RGB images and timestamped raw depth images.

To obtain corresponding RGB and depth pixels, the RGB and depth images are synced and aligned, meaning each pixel in the RGB image corresponds to a depth value in the depth image. In an aligned depth image, each pixel's depth corresponds to the distance between the camera and the object at that pixel. To extract object features or obtain a bounding box in the RGB image one may use object detection such as an object detection algorithm YOLO on the RGB image to detect the object of interest. This step provides a bounding box or coordinates of the object in the image. Alternatively, one may use feature extraction techniques such as Scale-Invariant Feature Transform (SIFT), a computer vision algorithm that extracts and describes local features in images, and detects distinctive keypoints in an image that are invariant to scale, rotation, and minor changes in illumination or viewpoint. Or one may use Oriented FAST and Rotated BRIEF (ORB) open software. ORB is a fusion of the features from accelerated segment test (FAST) keypoint detector and the Binary Robust Independent Elementary Features (BRIEF) open software descriptor. ORB uses FAST to find keypoints, then applies a Harris corner measure to find top N points among them. ORB also uses pyramid to produce multiscale-features or keypoint matching to identify the object in the RGB image. BRIEF uses binary strings as the efficient point descriptors by performing intensity difference tests.

The next step is to map the object's pixel coordinates to 3D space using the depth image. For each pixel of the detected object (e.g., the center of the bounding box or keypoints), the corresponding depth value can be used to reconstruct the 3D location in the camera coordinate system. One of skill can use the camera intrinsic matrix (calibration matrix) K of the RGB camera for such reconstruction. The intrinsic matrix typically contains the focal lengths and the principal point of the camera, which allow transformation of the 2D pixel coordinates to 3D camera coordinates.

The 3D coordinates (X, Y, Z) of the object can be computed using the following equations:

$$X = \frac{( u - {c}_{x} ) d ( u , v )}{{f}_{x}} \qquad Eq . 5$$

$$Y = \frac{( v - {c}_{y} ) d ( u , v )}{{f}_{y}} \qquad Eq . 6$$

$$Z = d ( u , v ) \qquad Eq . 7$$

wherein pixel coordinates of the object in the image are (u,v), the corresponding depth at that pixel in the depth image is d(u,v) and the 3D coordinates are (X, Y, Z). The object position in the camera frame can be converted to world frame, if needed, using the odometry.

Table 1 below provides an illustrative message size per topic for 3D mapping with raw images having M-JPEG compression for size reduction.

TABLE 1

| | | | Bandwidth Usage | | Bandwidth Usage | |
|---|---|---|---|---|---|---|
| Topic | Message Size | | (1 Hz) | | (5 Hz) | |
| Colored image | 15-30 | KB | 120-240 | Kbps | 0.6-1.2 | Mbps |
| Depth image | 15-35 | KB | 120-270 | Kbps | 0.6-1.35 | Mbps |
| Odometry | 56 | B | 488 | bps | 2.24 | bps |
| Signal Quality | 2 | B | 16 | bps | 80 | bps |
| Timestamp | 9 | B | 72 | bps | 360 | bps |
| Total | 30-65 | KB | 240-510 | Kbps | 1.2-2.55 | Mbps |

Table 2 below illustrates a preferred message size per topic for 3D mapping with raw images having M-JPEG compression for size reduction.

TABLE 2

| | | | Bandwidth Usage | | Bandwidth Usage | |
|---|---|---|---|---|---|---|
| Topic | Message Size | | (0.5 Hz) | | (5 Hz) | |
| Colored image | 30 | KB | 120 | Kbps | 1.2 | Mbps |
| Depth image | 30 | KB | 120 | Kbps | 1.2 | Mbps |
| Odometry | 56 | B | 240 | bps | 2.4 | Kbps |
| Signal Quality | 2 | B | 8 | bps | 80 | bps |
| Timestamp | 9 | B | 36 | bps | 360 | bps |
| Total | 60 | KB | 240 | Kbps | 2.4 | Mbps |

It can be seen that the present invention unexpectedly enables a drone 55 to efficiently transfer data within sub-GHz WiFi and bandwidth-constrained environments, operating in large indoor environments or other target sites 56 and to do so without the need for a WiFi extender. The present invention may be used with RTAB-Map operating on a common laptop.

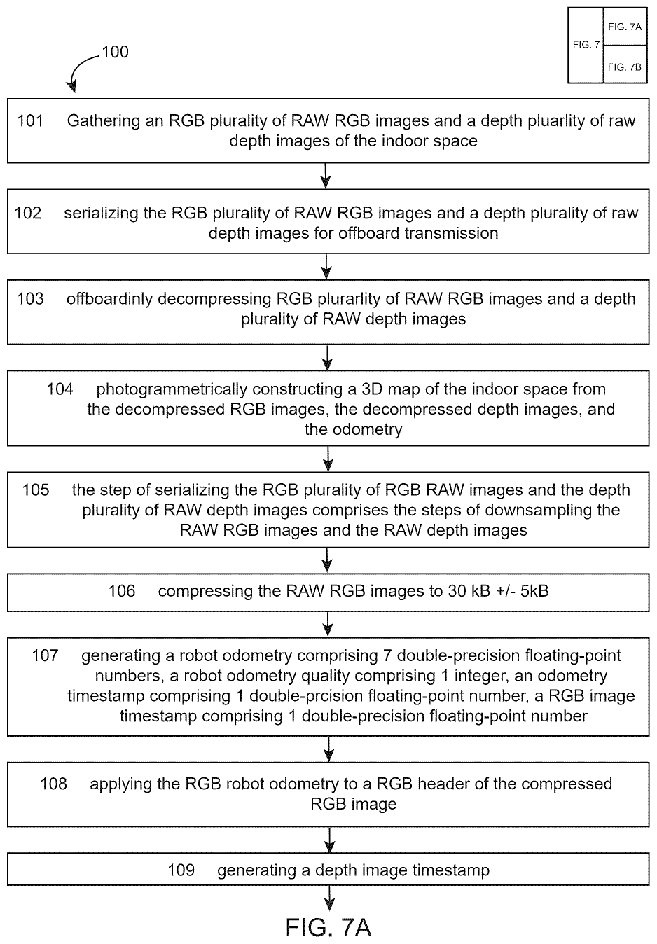

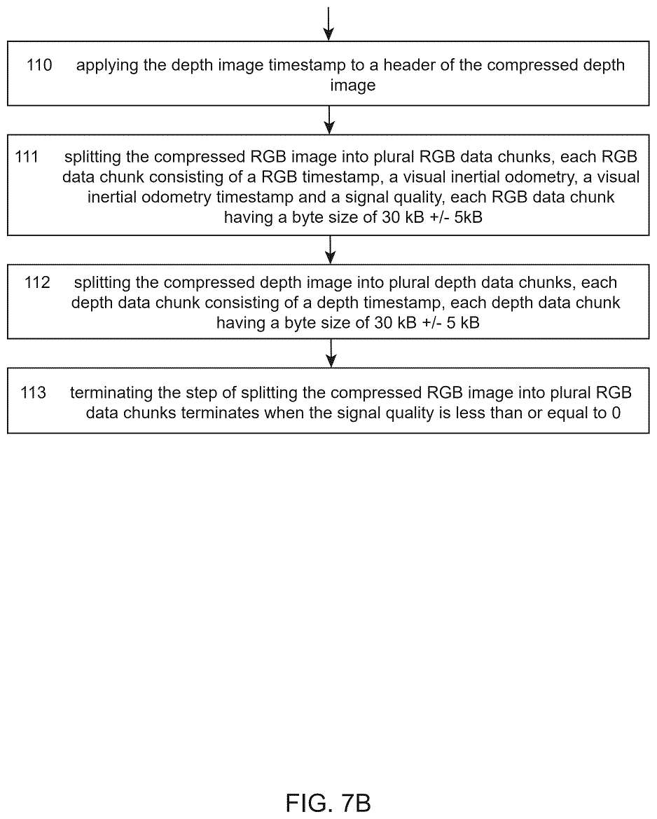

Referring to FIG. 7, in one embodiment the invention is a method 100 of creating a 3D image of a target site 56, preferably a predetermined target site, comprising the steps of: gathering an RGB plurality of raw RGB images and a depth plurality of raw depth images of the target site 56 101; serializing the RGB plurality of raw RGB images and a depth plurality of raw depth images for offboard transmission 102; offboardingly decompressing RGB plurality of raw RGB images and a depth plurality of raw depth images 103; photogrammetrically constructing a 3D map of the target site 56 from the decompressed RGB images, the decompressed depth images, and the odometry 104; the step of serializing the RGB plurality of RGB raw images and the depth plurality of raw depth images comprising the steps of downsampling the raw RGB images and the raw depth images 105; compressing the raw RGB images to 30 kB+/−5 kB 106; generating a robot odometry comprising 7 double-precision floating-point numbers, a robot odometry quality comprising 1 integer, an odometry timestamp comprising 1 double-precision floating-point number, a RGB image timestamp comprising 1 double-precision floating-point number 107; applying the RGB robot odometry to a RGB header of the compressed RGB image 108; generating a depth image timestamp 109; applying the depth image timestamp to a header of the compressed depth image 110; splitting the compressed RGB image into plural RGB data chunks, each RGB data chunk consisting of a RGB timestamp, a visual inertial odometry, a visual inertial odometry timestamp and a signal quality, each RGB data chunk having a byte size of 30 kb+/−5 kB 111; splitting the compressed depth image into plural depth data chunks, each depth data chunk consisting of a depth timestamp, each depth data chunk having a byte size of 30 kb+/−5 kB 112 and terminating the step of splitting the compressed RGB image into plural RGB data chunks terminates when the signal quality is less than or equal to 0 113.

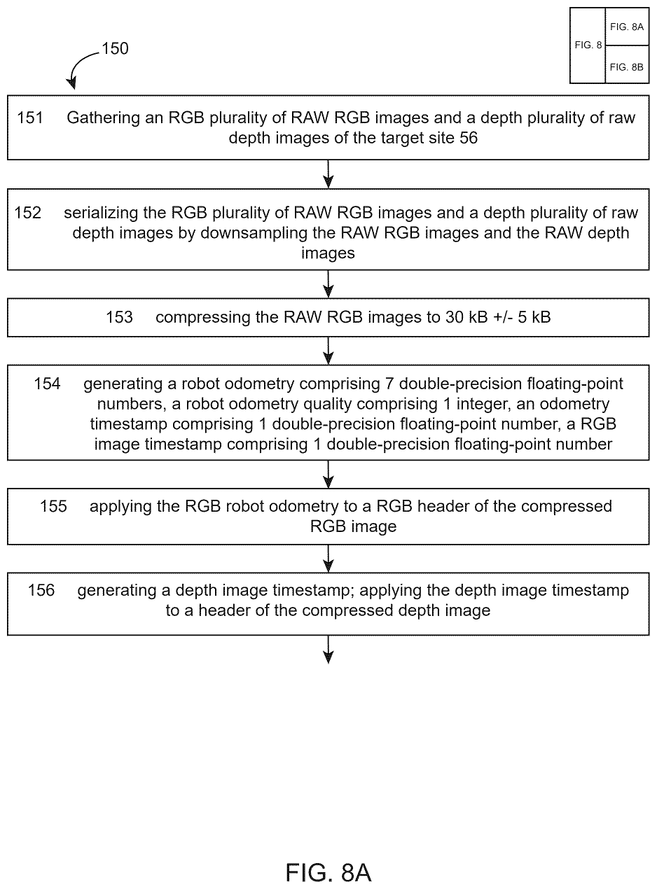

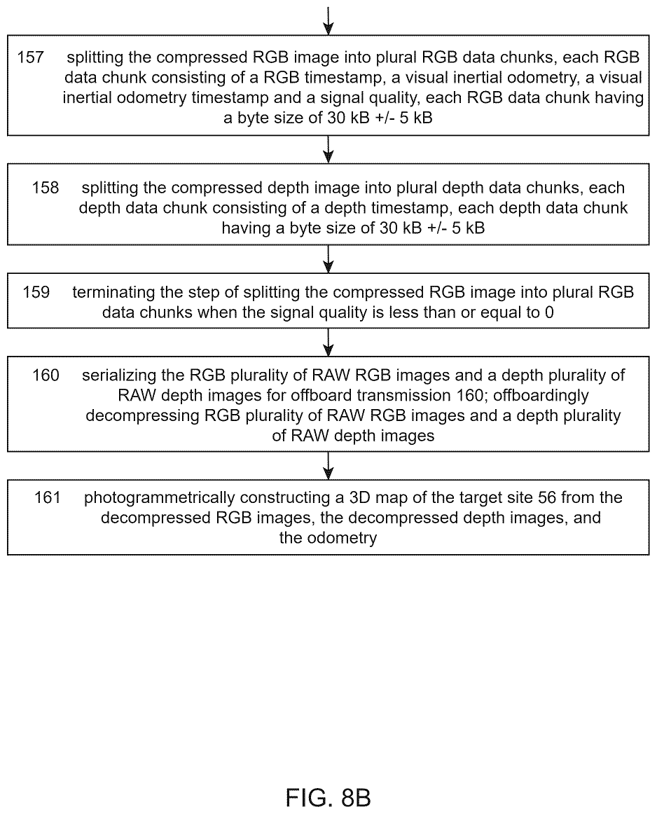

Referring to FIG. 8, in one embodiment the invention is a method 150 of creating a 3D image of a target site 56, such as a confined target site, the method comprising the steps of: gathering an RGB plurality of raw RGB images and a depth plurality of raw depth images of the target site 56 151; serializing the RGB plurality of RGB raw images and the depth plurality of raw depth images by downsampling the raw RGB images and the raw depth images 152; compressing the raw RGB images to 30 kB+/−5 kB 153; generating a robot odometry comprising 7 double-precision floating-point numbers, a robot odometry quality comprising 1 integer, an odometry timestamp comprising 1 double-precision floating-point number, a RGB image timestamp comprising 1 double-precision floating-point number 154; applying the RGB robot odometry to a RGB header of the compressed RGB image 155; generating a depth image timestamp; applying the depth image timestamp to a header of the compressed depth image 156; splitting the compressed RGB image into plural RGB data chunks, each RGB data chunk consisting of a RGB timestamp, a visual inertial odometry, a visual inertial odometry timestamp and a signal quality, each RGB data chunk having a byte size of 30 kb+/−5 kB 157; splitting the compressed depth image into plural depth data chunks, each depth data chunk consisting of a depth timestamp, each depth data chunk having a byte size of 30 kb+/−5 kB 158; terminating the step of splitting the compressed RGB image into plural RGB data chunks when the signal quality is less than or equal to 0 159; serializing the RGB plurality of raw RGB images and a depth plurality of raw depth images for offboard transmission 160; offboardingly decompressing RGB plurality of raw RGB images and a depth plurality of raw depth images 161; and photogrammetrically constructing a 3D map of the target site 56 from the decompressed RGB images, the decompressed depth images, and the odometry 162.

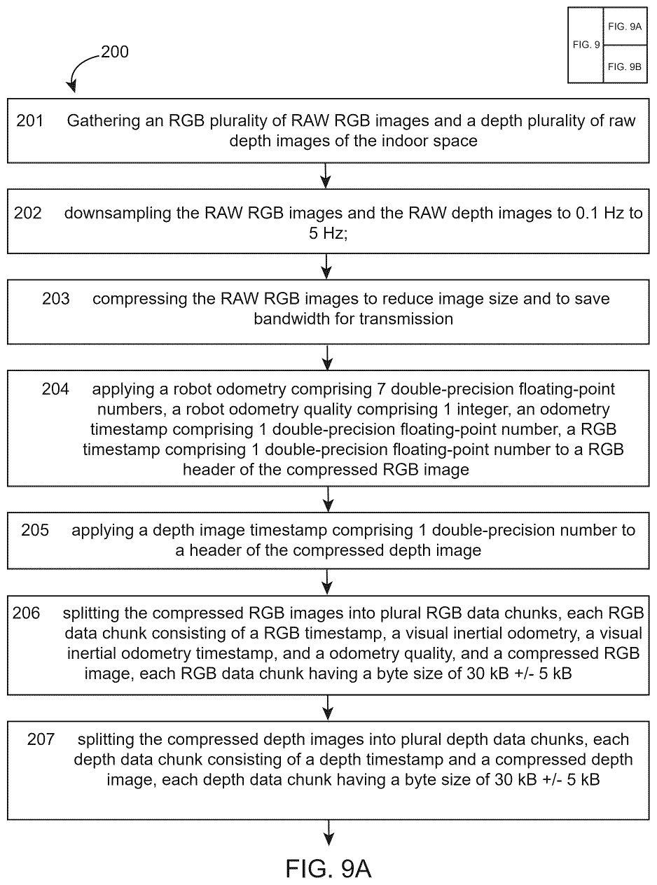

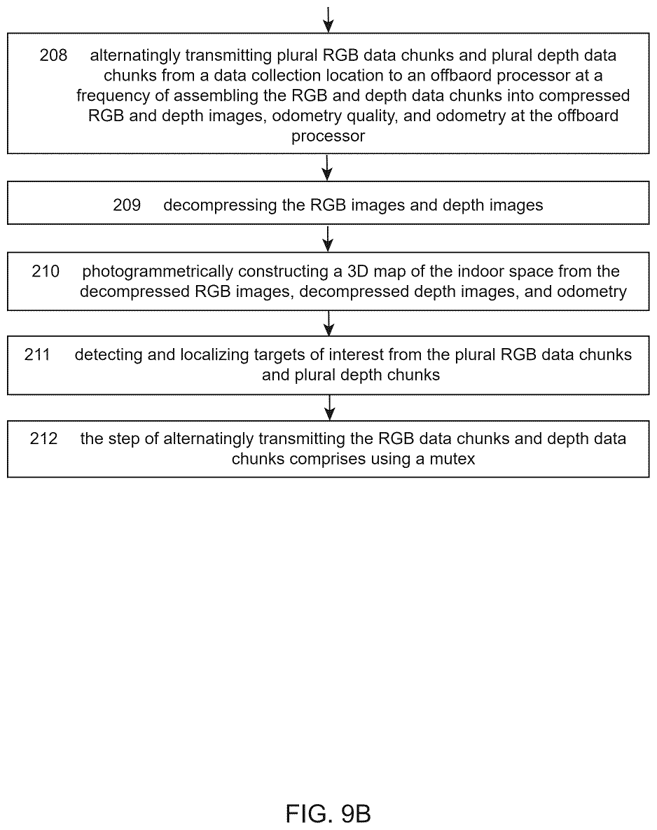

Referring to FIG. 9, in one embodiment the invention is a method 200 of creating a 3D image of a target site 56, such as a known target site, which is preferably an target site, comprising the steps of: gathering an RGB plurality of raw RGB images and a depth plurality of raw depth images of the target site 56 201; downsampling the raw RGB images and the raw depth images to 0.5 Hz to 5 Hz 202; compressing the raw RGB images to reduce image size and to save bandwidth for transmission 203; applying a robot odometry comprising 7 double-precision floating-point numbers, a robot odometry quality comprising 1 integer, an odometry timestamp comprising 1 double-precision floating-point number, a RGB image timestamp comprising 1 double-precision floating-point number to a RGB header of the compressed RGB image 204; applying a depth image timestamp comprising 1 double-precision number to a header of the compressed depth image 205; splitting the compressed RGB images into plural RGB data chunks, each RGB data chunk consisting of a RGB timestamp, a visual inertial odometry, a visual inertial odometry timestamp, and a odometry quality, and a compressed RGB image, each RGB data chunk having a byte size of 30 kb+/−5 kb 206; splitting the compressed depth images into plural depth data chunks, each depth data chunk consisting of a depth timestamp and a compressed depth image, each depth data chunk having a byte size of 30 kb+/−5 kb 207; alternatingly transmitting plural RGB data chunks and plural depth data chunks from a data collection location to an offboard processor 57 at a frequency of assembling the RGB and depth data chunks into compressed RGB and depth images, odometry quality, and odometry at the offboard processor 208; decompressing the RGB images and depth images 209; photogrammetrically constructing a 3D map of the target site 56 from the decompressed RGB images, decompressed depth images, and odometry 210; detecting and localizing targets of interest from the plural RGB data chunks and plural depth chunks 211; wherein the step of alternatingly transmitting the RGB data chunks and depth data chunks comprises using a mutex 212.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A method of creating a three dimensional (3D) image of a target site, the method comprising the steps of:
a) gathering a RGB plurality of raw RGB images of the target site and a depth plurality of raw depth images of the target site;
b) serializing the RGB plurality of raw RGB images and the depth plurality of raw depth images for offboard transmission;
c) offboardingly decompressing RGB plurality of raw RGB images and a depth plurality of raw depth images; and
d) photogrammetrically constructing a 3D map of the target site from the decompressed RGB images, the decompressed depth images, and the odometry.

2. The method according to claim 1 wherein the step of serializing the RGB plurality of RGB raw images and the depth plurality of raw depth images comprises the steps of:
e) downsampling the raw RGB images and the raw depth images;
f) compressing the raw RGB images to 30 kB+/−5 kB;
g) generating a robot odometry comprising 7 double-precision floating-point numbers, a robot odometry quality comprising 1 integer, an odometry timestamp comprising 1 double-precision floating-point number, a RGB image timestamp comprising 1 double-precision floating-point number;
h) applying the RGB robot odometry to a RGB header of the compressed RGB image;
i) generating a depth image timestamp;
j) applying the depth image timestamp to a header of the compressed depth image;
k) splitting the compressed RGB image into plural RGB data chunks, each RGB data chunk consisting of a RGB timestamp, a visual inertial odometry, a visual inertial odometry timestamp and a signal quality, each RGB data chunk having a byte size of 30 kb+/−5 kB; and
l) splitting the compressed depth image into plural depth data chunks, each depth data chunk consisting of a depth timestamp, each depth data chunk having a byte size of 30 kb+/−5 kB.

3. The method according to claim 2 wherein the step of splitting the compressed RGB image into plural RGB data chunks terminates when the signal quality is less than or equal to 0.

4. A method of creating a three dimensional (3D) image of a target site, the method comprising the steps of:
gathering an RGB plurality of raw RGB images and a depth plurality of raw depth images of the target site;
downsampling the raw RGB images and the raw depth images to 0.5 Hz to 5 Hz;
compressing the raw RGB images to reduce image size and to save bandwidth for transmission;
applying a robot odometry comprising 7 double-precision floating-point numbers, a robot odometry quality comprising 1 integer, an odometry timestamp comprising 1 double-precision floating-point number, a RGB image timestamp comprising 1 double-precision floating-point number to a RGB header of the compressed RGB image;
applying a depth image timestamp comprising 1 double-precision number to a header of the compressed depth image;
splitting the compressed RGB images into plural RGB data chunks, each RGB data chunk consisting of a RGB timestamp, a visual inertial odometry, a visual inertial odometry timestamp, and a odometry quality, and a compressed RGB image, each RGB data chunk having a byte size of 30 kb+/−5 kb;
splitting the compressed depth images into plural depth data chunks, each depth data chunk consisting of a depth timestamp and a compressed depth image, each depth data chunk having a byte size of 30 kb+/−5 kb;
alternatingly transmitting plural RGB data chunks and plural depth data chunks from a data collection location to an offboard processor at a frequency of 0.5 Hz to 5 Hz;
assembling the RGB and depth data chunks into compressed RGB and depth images, odometry quality, and odometry at the offboard processor;
decompressing the RGB images and depth images; and
photogrammetrically constructing a 3D map of the target site from the decompressed RGB images, decompressed depth images, and odometry.

5. The method according to claim 4 further comprising the step of detecting and localizing targets of interest from the plural RGB data chunks and plural depth chunks.

6. The method according to claim 5 further wherein the step of alternatingly transmitting the RGB data chunks and depth data chunks comprises using a mutex.

7. The method according to claim 6 wherein the step of alternatingly transmitting the RGB data chunks and depth data chunks comprises transmitting the RGB data chunks and depth data chunks through a TCP/IP socket.

8. A method of creating a 3D image of a target site, the method comprising the steps of:
gathering an RGB plurality of raw RGB images and a depth plurality of raw depth images of the target site;
serializing the RGB plurality of RGB raw images and the depth plurality of raw depth images comprising the steps of downsampling the raw RGB images and the raw depth images;
compressing the raw RGB images to 30 kB+/−5 kB; generating a robot odometry comprising 7 double-precision floating-point numbers, a robot odometry quality comprising 1 integer, an odometry timestamp comprising 1 double-precision floating-point number, a RGB image timestamp comprising 1 double-precision floating-point number;
applying the RGB robot odometry to a RGB header of the compressed RGB image;
generating a depth image timestamp;
applying the depth image timestamp to a header of the compressed depth image;
splitting the compressed RGB image into plural RGB data chunks, each RGB data chunk consisting of a RGB timestamp, a visual inertial odometry, a visual inertial odometry timestamp and a signal quality, each RGB data chunk having a byte size of 30 kb+/−5 kB;
splitting the compressed depth image into plural depth data chunks, each depth data chunk consisting of a depth timestamp, each depth data chunk having a byte size of 30 kb+/−5 kB and terminating the step of splitting the compressed RGB image into plural RGB data chunks terminates when the signal quality is less than or equal to 0;
serializing the RGB plurality of raw RGB images and a depth plurality of raw depth images for offboard transmission;
offboardingly decompressing RGB plurality of raw RGB images and a depth plurality of raw depth images; and
photogrammetrically constructing a 3D map of the target site from the decompressed RGB images, the decompressed depth images, and the odometry.
